(19) United States
(12) Patent Application Publication
(10) Pub. No.: US 2011/0014027 A1
(43) Pub. Date: Jan. 20, 2011

(54) LIFT AND MOUNT APPARATUS

(75) Inventors: Jared J. Drader, Carlsbad, CA (US); Steven A. Hofstadler, Vista, CA (US); Jose R. Gutierrez, San Marcos, CA (US); Paul J. Gleason, Laguna Niguel, CA (US); Andrew J. Scherer, Trabuco Canyon, CA (US); Rex O. Bare, Lake Forest, CA (US)

Correspondence Address: Casimir Jones, S.C., 2275 Deming Way, Suite 310, Madison, WI, 53562, US

(73) Assignee: IBIS BIOSCIENCES, INC., Carlsbad, CA (US)

(21) Appl. No.: 12/837,245

(22) Filed: Jul. 15, 2010

Related U.S. Application Data
(60) Provisional application No. 61/226,339, filed on Jul. 17, 2009.

(51) Int. Cl. A47B 81/00; B66D 1/00; B66C 19/00; A47B 96/00

(52) U.S. Cl. 414/800; 211/1.51

(57) ABSTRACT

The present invention provides devices, apparatuses, and systems for lifting and mounting of clinical- and research-related equipment. In particular, the present invention provides a lift and mount system for mass spectrometers (e.g., for time of flight (TOF) mass spectrometers (MS)).

### CROSS REFERENCE TO RELATED APPLICATIONS

The present Application claims priority to PCT Patent Application No. ______ filed Jul. 16, 2010 (filed concurrently herewith) and U.S. Provisional Application Ser. No. 61/226,339 filed Jul. 17, 2009, the entirety of each of which is herein incorporated by reference.

### FIELD OF THE INVENTION

The present invention provides devices, apparatuses, and systems for lifting and mounting of clinical- and research-related equipment. In particular, the present invention provides a lift and mount system for mass spectrometers (e.g., for time of flight (TOF) mass spectrometers (MS)).

### BACKGROUND

Many biomedical, biochemical, and biophysical clinical and research equipment and instruments are large and unwieldy. Further, these devices require careful handling, transport, and mounting to protect sensitive and expensive elements of the equipment. Devices within this category include, but are not limited to mass spectrometers (e.g. TOF-MS), chromatography equipment (e.g. HPLC), scintillation counters, microscope systems, etc.

### SUMMARY

The present invention provides devices, apparatuses, and systems for lifting and mounting of clinical- and research-related equipment. In certain exemplary embodiments, the present invention provides a lift and mount system for mass spectrometers (e.g., for time of flight (TOF) mass spectrometers (MS) of TOF-MS) (see e.g., those devices and components of such devices described in U.S. Pat. Appln. Ser. Nos. 61/152,214, 29/328,150, 29/328,151, 29/330,905, and 29,330,904, herein incorporated by reference in their entireties; see also T5000 device of Ibis Biosciences, Inc.). In some embodiments, the devices, apparatuses, and systems provide a safe and secure scaffold for moving, positioning, mounting, and using a large and/or heave analytical machine.

In some embodiments, the present invention provides a system comprising: (a) an device, wherein the device comprises a biomedical, biophysical, or biochemical device, and (b) an apparatus, wherein the apparatus comprises (i) a mounting assembly and (ii) a structural assembly, wherein the structural assembly comprises a platform member, wherein the mounting assembly is configured to lift the device to a height higher than the height of the platform member, wherein the mounting assembly is configured to retract the device into a position directly above the platform member, wherein the mounting assembly is configured to lower the device onto the platform member, and wherein the structural assembly and the platform member are configured to stably support the device. In some embodiments, the mounting assembly is supported by the structural assembly. In some embodiments, the mounting assembly is located atop the structural assembly. In some embodiments, the mounting assembly comprises a lifting assembly and a retracting assembly. In some embodiments, the retracting assembly is configured to extend the lifting assembly beyond the front of the structural assembly, and the retracting assembly is configured retract the lifting assembly within the structural assembly and above the platform member. In some embodiments, the lifting assembly comprises one or more device engagement members, wherein the device engagement members extend from the lifting assembly to the device, and wherein the device engagement members are configured to stably engage and support the device. In some embodiments, the device engagement members are configured to retract toward the top of the system, thereby lifting the device. In some embodiments, the lifting assembly is configured to lift the device to a height which is higher than the height of the platform member. In some embodiments, the retracting assembly is configured retract the lifting assembly and the device within the structural assembly and directly above the platform member. In some embodiments, the lifting assembly is configured to extend the device engagement members, thereby setting the device onto the platform member. In some embodiments, the present invention comprises an accessory assembly, wherein the accessory assembly is configured to support one or more accessory devices, wherein the accessory devices are configured to function in conjunction with the device (e.g., in fluid, electronic, or mechanical communication with the device). In some embodiments, the accessory assembly is attached to the structural assembly. In some embodiments, the device comprises a mass spectrometer.

The present invention further provides apparatuses, as described above, lacking the device (e.g., but configured for moving, mounting, or using such a device). In some embodiments, the present invention provides an apparatus comprising: (a) a structural assembly and (b) a mounting assembly, wherein the mounting assembly is located atop the structural assembly and the mounting assembly is supported by the structural assembly, wherein the structural assembly comprises a platform member, wherein the mounting assembly comprises a lifting assembly and a retracting assembly, wherein the lifting assembly is configured to lift the device to a height higher than the height of the platform member, wherein the retracting assembly is configured to retract the lifting assembly and the device into a position directly above the platform member, wherein the lifting assembly is configured to lower the device onto the platform member, and wherein the structural assembly and the platform member are configured to stably support the device. In some embodiments, the device comprises a mass spectrometer. In some embodiments, the lifting assembly comprises a device engagement member.

The present invention further provides methods of moving, positioning, mounting, and using devices. For example, in some embodiments, the present invention provides a method comprising: (a) providing: (i) an apparatus as described in any of the embodiments herein, and (ii) a device, (b) engaging of the device with the device engagement member of the lifting assembly of the apparatus, (c) lifting the device by the lifting assembly of the apparatus, wherein lifting comprises lifting the device to a height wherein the bottom of the device reaches a height higher than the platform member of the apparatus, (d) retracting the device and the lifting assembly by the retracting assembly, wherein retracting results in the device being positioned above the platform member, and (e) lowering the device by the lifting assembly of the apparatus, wherein lowering results in the device being positioned onto the platform member. In some embodiments, the present invention further comprises using the device for its designated purpose. In some embodiments, the device comprises a mass spectrometer.

### DESCRIPTION OF FIGURES

The foregoing summary and detailed description may be better understood when read in conjunction with the accompanying drawings which are included by way of example and not by way of limitation.

FIG. 1 shows a schematic of an exemplary apparatus in the unmounted conformation.

FIG. 2 shows a schematic of an exemplary apparatus with a mounted TOF-MS.

FIG. 3 shows a schematic of an exemplary apparatus: A) prior to mounting a TOF-MS, and B) with a mounted TOF-MS.

FIG. 4 shows a schematic of the right view of an exemplary apparatus: A) prior to mounting a TOF-MS, and B) with a mounted TOF-MS.

FIG. 5 shows a schematic of the top view of an exemplary apparatus: A) prior to mounting a TOF-MS, and B) with a mounted TOF.

### DETAILED DESCRIPTION

The present invention provides devices, apparatuses, and systems for lifting and mounting of clinical- and research-related equipment. In certain embodiments, for example, the present invention provides a lifting and mounting system for mass spectrometers (e.g., time of flight (TOF) mass spectrometers (MS)). In some embodiments, the present invention provides an apparatus, unit, assembly, system, rack, shelve, and/or device for mounting, storing, protecting, supporting, shelving, and/or holding a device, unit, apparatus, instrument, piece of equipment, etc. (e.g. mass spectrometers (e.g. TOF-MS, MALDI-TOF-MS, LC-MS, ESI-MS), chromatography equipment (e.g. high performance liquid chromatograph (HPLC), fast protein liquid chromatograph (FPLC), liquid chromatograph (LC), gas chromatograph (GC), supercritical-fluid chromatography (SFC), capillary electrokinetic chromatograph (CEC), etc.), scintillation counter, microscope systems (e.g. confocal microscope), spectrometer (e.g. IR spectrometer, UV-Vis. spectrometer, microwave spectrometer, x-ray spectrometer, emission spectrometer, fluorescence spectrometer, nuclear magnetic resonance spectrometer, etc.), x-ray generator, computers, etc.). Biomedical, biochemical, and biophysical research and clinical instruments may be large, unwieldy, and difficult to move and/or store. Further, research and clinical equipment may be delicate, containing precision elements that should be transported and stored with great care and sensitivity. In some embodiments, the present invention provides an apparatus for mounting, supporting, and storing clinical and research devices and equipment in a safe, effective manner. In some embodiments, an apparatus of the present invention is configured to support biomedical, biochemical, and/or biophysical devices and related equipment (e.g. computer, printer, reagents, power source, display unit, control unit, accessory units, etc.). In some embodiments, devices and equipment may be accessed by a user, manipulated, and used while stored in an apparatus of the present invention. In some embodiments, the present invention provides an apparatus for mounting, supporting, storing, and using a TOF-MS and any related equipment or accessories (e.g. computer, display, printer, reagents, nucleic acid or protein processing components (e.g., thermocyclers), etc.).

Illustrative embodiments of the apparatuses are described in more detail below. The invention is not limited to these particular embodiments.

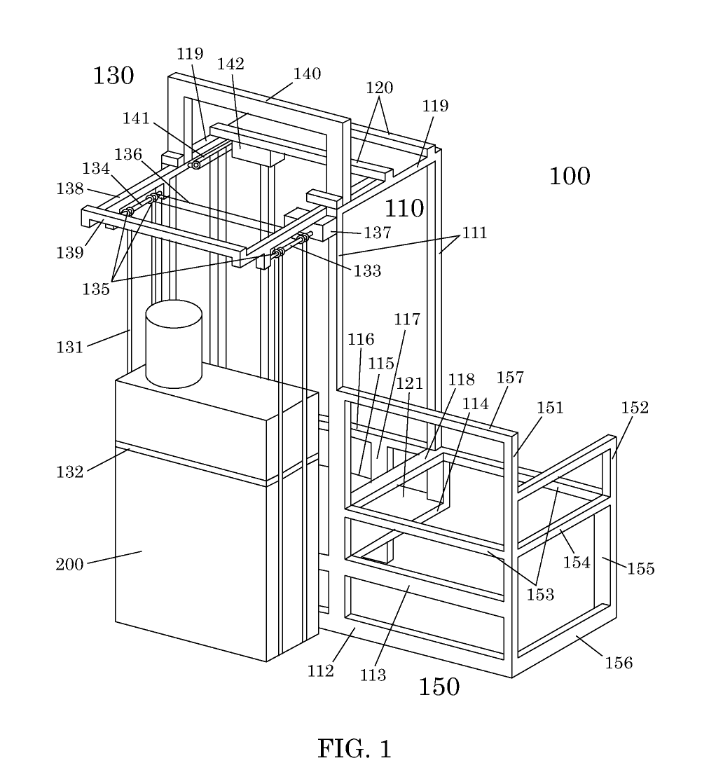

As shown in FIG. 1, in some embodiments, the present invention provides an apparatus 100 for mounting and supporting a device 200 (exemplified as a TOF-MS in the figure). The apparatus provides a structural assembly 110 for supporting a device 200, and a mounting assembly 130 for mounting and unmounting the device 200 onto and off of the structural assembly 110.

In some embodiments, the apparatus 100 comprises a structural assembly 110. The structural assembly 110 comprises a plurality of support members (e.g. bars, rails, posts, beams, walls, etc.) including four vertical support members 111 (although more or less can be used), a front base member 112, a front support member 113, and two side support members 114 (one not within view in FIG. 1), a rear support member 115, rear restraint member 116, rear vertical member 117, two side restraint members 118 (one not within view in FIG. 1), two upper support members 119, and two top support members 120. The support members 120 provide support for the apparatus 100, the device 200, and the mounting assembly 130. Configurations of the support members other than the embodiments depicted in FIG. 1 are also contemplated. For example, additional side restraint members 118 and rear restraint members 116 may be utilized to provide additional support and restraint for the device 200, multiple rear vertical members 117, or additional top support members 120 may play roles in attaching and supporting the mounting assembly 130. Likewise, one or more of the support or restraint members may be absent, so long as sufficient architecture is present to mount the device 200. Attached to the side support members 114, rear support member 115, and front support member 113 is a platform member 121 which provides a placement location for the device 200, when mounted.

In some embodiments, the apparatus 100 comprises a mounting assembly 130. The mounting assembly 130 is configured to perform a lifting operation and a retracting operation. The lifting operation of the mounting assembly 130 is performed by two device engagement members 131, a device stability member 132, a primary lift rod 133, a secondary lift rod 134, four rod engagement members 135, a rod connection member 136, a lift motor 137 (e.g., a stepper motor, a servo motor, or the like), two side lift members 138, a front lift member 139, and a top lift member 140. In some embodiments, device engagement members 131 comprise straps or belts which extend from a rod engagement member 135 attached to the primary lift rod 133 to a second rod engagement member 135 attached to the secondary lift rod 134. The device engagement members 131 are configured to extend to the level of the front base member 112 and beneath the device 200. In some embodiments, rod engagement members 135 comprise wheels or tracks on the primary lift rod 133 and secondary lift rod 134 which are configured to engage the device engagement members and provide stability of the interaction between the device engagement members 131 and the primary lift rod 133 and secondary lift rod 134 during lifting. In some embodiments, the lift motor 137 is functionally attached to the primary lift rod 133. Turning of the lift motor 137 results in simultaneous turning of the primary lift rod 133. The rod connection member 136 engages both the primary lift rod 135 and the secondary lift rod 134. Turning of the primary lift rod 133 results in turning of the secondary lift rod 134 through the action of the rod connection member 136. Therefore, turning of the lift motor 137 results in the simultaneous turning of the primary lift rod 133 and the secondary lift rod 134 in the same rotary direction. Turning of the primary lift rod 133 and secondary lift rod 134 causes the device engagement members 131 to retract, thereby lifting the device 200 up from the level of the front base member 112. The lift motor 137, primary lift rod 133, secondary lift rod 134, rod engagement members 135, rod connection member 136, and device engagement members 131 are configured to lift the device 200 so that the bottom of the device 200 is higher than the level of the platform member 121. One or more device stability members 132 extend around the device 200 and the device engagement members 131 to stabilize and secure the device 200 during lifting. Support for the mounting assembly 130 during lifting is provided by two side lift members 138, a front lift member 139, and a top lift member 140.

In some embodiments, the retracting operation of the mounting assembly 130 is performed by a retraction member 141 and the retraction motor 142 (e.g., a stepper motor, a servo motor, or the like). Movement of the retraction member 141 by the retraction motor 142 results in the retraction of the primary lift rod 134 and secondary lift rod 134, as well as the attached rod engagement members 135, device engagement members 131, device stability member 132, rod connection member 136, and lift motor 137 into the mounted position above the platform member 121.

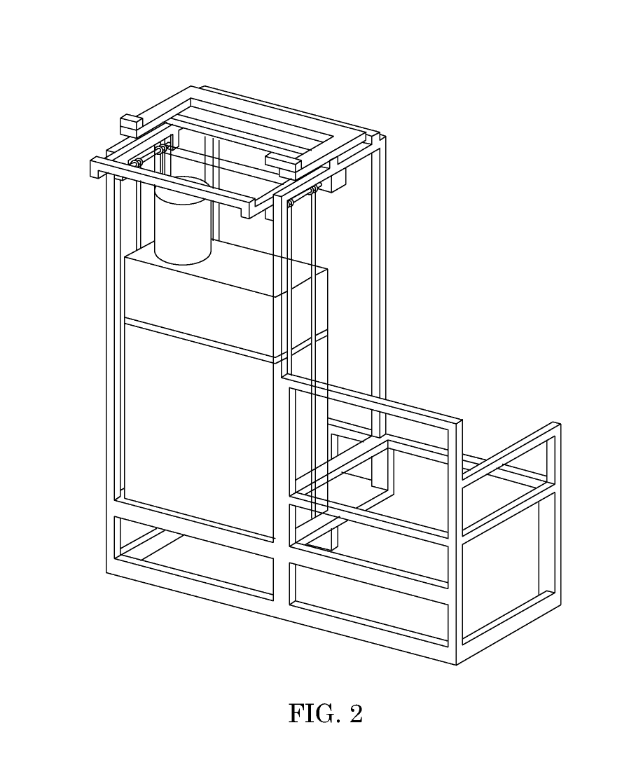

Upon refraction, the mounting assemble 130 is configured to lower the device 200 onto the platform assembly 118. Lowering of the device 200 is carried out by turning of the lift motor 137 in the opposite direction as during lifting. Turning of the lift motor 137 results in rotation of the primary lift rod 133, movement of the rod connection member 136, rotation of the secondary lift member 134, extension of the device engagement members 131, and lowering of the device 200 onto the platform member 118. Upon placement of the device 200 onto the platform member 121, the side lift members 138 and front lift member 139 can be removed or retracted, and the top lift member 140 can adopt a collapsed conformation (SEE FIG. 2). The same lowering mechanism is performed when the mounting assembly 130 is in the extended conformation to lower a device 200 onto the ground in front of the apparatus 100. In some embodiments, additional support structures are included to increase the load bearing capacity of the side lift members 138 and the front lift member 139. For example, in some embodiments, one or more additional support members, straps, cables, or other components connect the front lift member 139 and/or the side lift members 138 (or any other component of the mounting assembly 130) to the structural assembly 110, for example, to the support members 120 of the structural assembly 110.

In some embodiments, the apparatus 100 comprises an accessory assembly 150. In some embodiments the accessory assembly 150 attaches to the structural assembly 110 at the front base member 112, vertical support members 111, rear restraint member 116, side restraint member 118, front support member 113, and rear restraint member 116. The accessory assembly 150 comprises the front base member 112, front support member 113, accessory vertical member 151, accessory side restraint 152, accessory support members 153, accessory side support 154, accessory vertical support 155, accessory base member 156, and accessory top restraint 157. Many configurations of the accessory assembly 150 are within the scope of the present invention. For example, in some embodiments the accessory assembly 150 comprises front and rear accessory top restraints 157. In some embodiments, the accessory assembly 150 comprises a rear accessory base member. In some embodiments, the accessory assembly 150 lacks an accessory side restraint 152 and accessory top restraint 157. In some embodiments, the apparatus 100 lacks an accessory assembly 150. In some embodiments, the apparatus 100 comprises multiple accessory assemblies 150 (e.g. located in front, right side, left side, rear, serially connected, etc.).

In some embodiments, the mounting assembly 130 comprises a lifting assembly and a retracting assembly. In some embodiments, the lifting assembly and a retracting assembly comprise separate motors (e.g. 137 and 142). In some embodiments, a single motor drives the lifting assembly and the retracting assembly (e.g. 137). In some embodiments, a motor engages both the retracting assembly and the lifting assembly. In some embodiments, the lifting assembly is driven by a motor (e.g. 137). In some embodiments, the lifting motor is electric powered (e.g. AC powered, battery powered, etc.). In some embodiments, the lifting motor powers the lifting assembly by directly turning one or more gears, chains, belts, rods (e.g. 133), etc. In some embodiments, the lifting motor (e.g. 137) powers the lifting assembly by indirectly turning one or more gears, chains, belts, rods (e.g. 134), etc. In some embodiments, one or more gears or rods (e.g. 133 or 134) turned by the lifting motor (e.g. 137) directly engage one or more device engagement members (e.g. 131). In some embodiments, one or more gears or rods (e.g. 133 or 134) turned by the lifting motor (e.g. 137) indirectly engage one or more device engagement members (e.g. through a chain, through a belt, through one or more gears, through a rod engagement member (e.g. 135), etc.). In some embodiments, a lifting motor (e.g. 137) directly turns a primary lift rod (e.g. 133), and indirectly (e.g. via a chain, via one or more gears, etc.) turns a secondary lifting rod (e.g. 134). In some embodiments, a primary (e.g. 133) and/or secondary lift rod (e.g. 134) is functionally attached to one or more device engagement members (e.g. 131). In some embodiments, a lifting motor turns a primary lift rod (e.g. 133) and a secondary lift rod (e.g. 134) in the same direction (e.g. clockwise or counterclockwise). In some embodiments, a lifting motor turns a primary lift rod (e.g. 133) and a secondary lift rod (e.g. 134) in opposite directions (e.g. clockwise and counterclockwise). In some embodiments, turning of a primary lift rod (e.g. 133) and/or a secondary lift rod (e.g. 134) and/or the rod engagement members (e.g. 135) results in retracting of one or more device engagement members (e.g. 131). In some embodiments, device engagement members (e.g. 131) comprise straps, cords, chains, cables, ropes, latches, hooks, etc. In some embodiments device engagement members (e.g. 131) are positioned under a device (e.g. 200) in order to lift the device (e.g. 200). In some embodiments device engagement members (e.g. 131) are attached to a device (e.g. 200) in order to lift the device (e.g. 200). In some embodiments device engagement members (e.g. 131) are configured to fit with a specific make, model, or type of device (e.g. 200). In some embodiments, device engagement members (e.g. 131) are generically configured to fit with all, most, or many large research or clinical devices (e.g. 200). In some embodiments, retracting one or more device engagement members (e.g. 131) via the lifting assembly results in lifting an attached or engaged device (e.g. 200).

In some embodiments, the retracting assembly is operatively associated, functionally associated, and/or attached to the lifting assembly. In some embodiments, the retracting assembly is configured to shuttle the lifting assembly from an extended conformation (SEE FIG. 1) (e.g. extended beyond the front or rear of the structural assembly 110) to a retracted conformation (SEE FIG. 2) (e.g.

retracted within the structural assembly 110, above the platform member 121). In some embodiments, the retracting assembly is configured to shuttle the lifting assembly from a refracted conformation (SEE FIG. 2) to an extended conformation (SEE FIG. 1). In some embodiments, the refracting assembly is powered by a motor (e.g. electric motor). In some embodiments, the retracting assembly is powered by the same motor as the lifting assembly. In some embodiments, the retracting assembly is powered by a different motor from the lifting assembly (e.g. 142). In some embodiments, the retracting motor (e.g. 142) turns one or more gears, rods, belts, and/or chains (e.g. retraction member 141) which result in extending or retracting the lifting assembly.

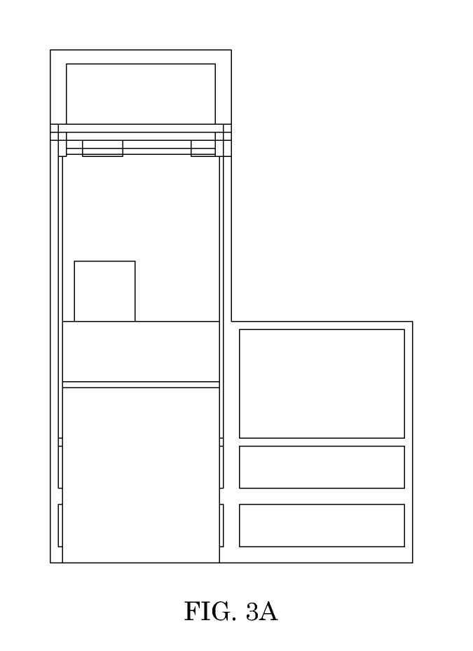

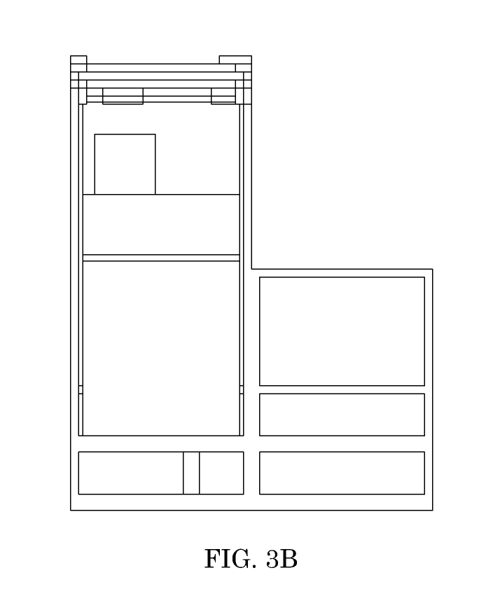

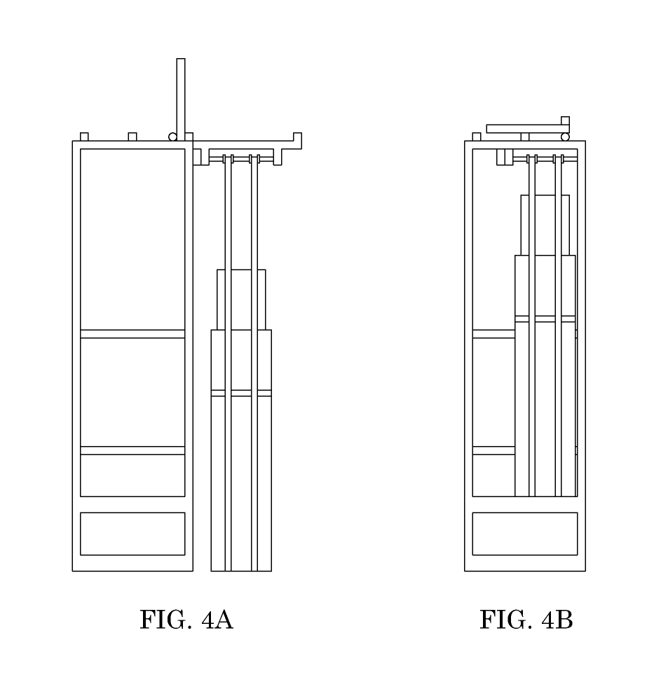

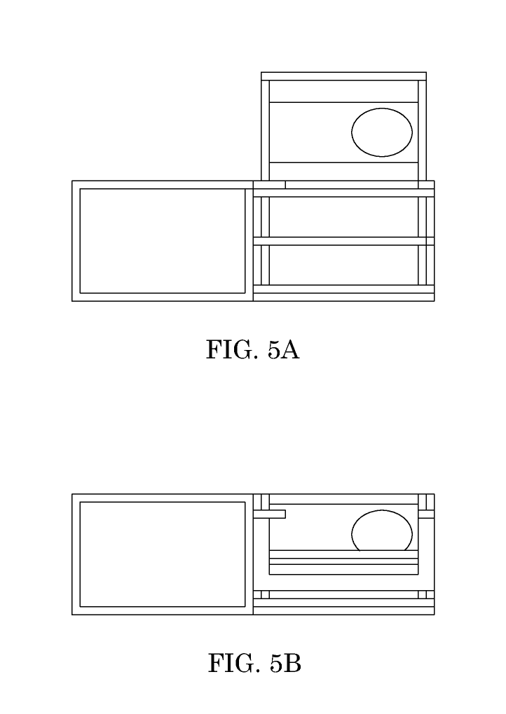

The present invention is not limited to the configurations depicted in the drawings (SEE FIG. 1-5). In some embodiments, the structural assembly 110 may be of any suitable configuration. In some embodiments, the structural assembly 110 comprises walls, windows, doors, drawers, shelves, panels, etc. In some embodiments, the structural assembly 110 comprises wheels, casters, sliders, etc. In some embodiments, the structural assembly 110 is mobile. In some embodiments, the structural assembly 110 is stationary. In some embodiments, the structural assembly 110 is configured to be attached to a wall or external support. In some embodiments, the structural assembly 110 is free standing.

In some embodiments, the structural assembly 110 comprises one or more vertical support members 111 (e.g. 1, 2 3, 4, 5, 6, 7, 8, 9, 10, 11, 12 13, 14, 15, 16, 17 18, 19, 20, >20). In some embodiments, vertical support members 111 are located at the corners of the structural assembly 110. In some embodiments vertical support members 111 are located along the front, right, left, or rear sides of the structural assembly 110. In some embodiments, vertical support members 111 extend from the bottom of the structural assembly 110 to the top of the structural assembly 110. In some embodiments, vertical support members 111 do not extend to the bottom of the structural assembly 110. In some embodiments, vertical support members 111 do not extend to the top of the structural assembly 110. In some embodiments, vertical support members 111 are attached to or in contact with other elements within the structural assembly 110 (e.g. front base member 112, front support member 113, side support member 114, rear support member 115, rear restraint member 116, side restraint member 118, upper support member 119, top support member 120, platform member 121, etc.), mounting assembly 130 (e.g. primary lift rod 133, secondary lift rod 134, lift motor 137, side lift member 138, front lift member 139, top lift member 140, retraction member 141, retraction motor 142, etc.), and/or accessory assembly 150 (e.g. accessory vertical member 151, accessory side restraint 152, accessory support member 153, accessory side support 154, accessory vertical support 155, accessory base member 156, accessory top restraint 157, etc.). In some embodiments, vertical support members 111 are attached to or in contact with other elements within the structural assembly 110, mounting assembly 130, and/or accessory assembly 150 through connector pieces (e.g. brackets, joints, connectors, screws, etc.).

In some embodiments, the structural assembly 110 comprises one or more front base members 112 (e.g. 1, 2 3, 4, 5, 6, 7, 8, 9, 10, >10). In some embodiments, a front base member 112 is positioned along the front of the apparatus 100. In some embodiments, a front base member 112 is positioned along the right, rear, or left side of the structural assembly 110. In some embodiments, a front base member comprises a portion of the structural assembly 110 and/or the accessory assembly 150.

In some embodiments, a front base member extends from a corner of the structural assembly 110 and/or the accessory assembly 150 to another corner. In some embodiments, one or both ends of a front base member terminates within the side of the structural assembly 110 and/or the accessory assembly 150 (e.g. not at a corner). In some embodiments, one or more front base members 112 are attached to or in contact with other elements within the structural assembly 110 (e.g. vertical support member 111 side support member 114, rear support member 115, rear vertical member 117, platform member 121, etc.), mounting assembly 130, and/or accessory assembly 150 (e.g. accessory vertical member 151, accessory side restraint 152, accessory support member 153, accessory side support 154, accessory vertical support 155, accessory base member 156, accessory top restraint 157, etc.) through direct interaction of through connector pieces (e.g. brackets, joints, connectors, screws, etc.).

In some embodiments, the structural assembly 110 comprises one or more front support members 113 (e.g. 1, 2 3, 4, 5, 6, 7, 8, 9, 10, >10), side support members 114 (e.g. 1, 2 3, 4, 5, 6, 7, 8, 9, 10, >10), and/or rear support members 115 (e.g. 1, 2 3, 4, 5, 6, 7, 8, 9, 10, >10). In some embodiments, a front support member 113 is positioned along the front of the apparatus 100. In some embodiments, a side support member 114 is positioned along the right or left side of the apparatus 100. In some embodiments, a rear support member 115 is positioned along the rear of the apparatus 100. In some embodiments, a front support member 113, side support member 114, and/or rear support member 115 is positioned along the front, right, rear, and/or left side of the structural assembly 110. In some embodiments, a front support member 113, side support member 114, and/or rear support member 115 comprises a portion of the structural assembly 110 and/or the accessory assembly 150. In some embodiments, a front support member 113, side support member 114, and/or rear support member 115 extends from a corner of the structural assembly 110 and/or the accessory assembly 150 to another corner. In some embodiments, one or both ends of a front support member 113, side support member 114, and/or rear support member 115 terminates within the side of the structural assembly 110 and/or the accessory assembly 150 (e.g. not at a corner). In some embodiments, one or more front support member 113, side support member 114, and/or rear support member 115 are attached to or in contact with other elements within the structural assembly 110 (e.g. vertical support member 111, rear vertical member 117, platform member 121, etc.), mounting assembly 130, and/or accessory assembly 150 (e.g. accessory vertical member 151, accessory side restraint 152, accessory support member 153, accessory side support 154, accessory vertical support 155, accessory base member 156, accessory top restraint 157, etc.) through direct interaction of through connector pieces (e.g. brackets, joints, connectors, screws, etc.). In some embodiments, one or more front support member 113, side support member 114, and/or rear support member 115 are attached to or in contact with (e.g. direct or through one or more connector pieces) one or more front support member 113, side support member 114, and/or rear support member 115.

In some embodiments, the apparatus 100 comprises one or more rear restraint members 116 (e.g. 1, 2 3, 4, 5, 6, 7, 8, 9, 10, >10), side restraint members 118 (e.g. 1, 2 3, 4, 5, 6, 7, 8, 9, 10, >10), accessory side restraints 152 (e.g. 1, 2 3, 4, 5, 6, 7, 8, 9, 10, >10), and/or accessory top restraints 157 (e.g. 1, 2 3, 4, 5, 6, 7, 8, 9, 10, >10). In some embodiments, one or more rear restraint members 116, side restraint members 118, accessory side restraints 152, and/or accessory top restraints 157 are configured to provide structural support for the apparatus 100 and/or device 200. In some embodiments, one or more rear restraint members 116, side restraint members 118, accessory side restraints 152, and/or accessory top restraints 157 are configured to restrain a device 100 and/or accessory equipment, and prevent a device 100 and/or accessory equipment from falling, slipping, dislodging, and/or shifting. In some embodiments, one or more rear restraint members 116, side restraint members 118, accessory side restraints 152, and/or accessory top restraints 157 extend from a corner of the structural assembly 110 and/or the accessory assembly 150 to another corner. In some embodiments, one or more rear restraint members 116, side restraint members 118, accessory side restraints 152, and/or accessory top restraints 157 terminates within the side of the structural assembly 110 and/or the accessory assembly 150 (e.g. not at a corner). In some embodiments, one or more rear restraint members 116, side restraint members 118, accessory side restraints 152, and/or accessory top restraints 157 comprise a linear element, corner element, and/or bent element. In some embodiments, one or more rear restraint members 116, side restraint members 118, accessory side restraints 152, and/or accessory top restraints 157 are attached to or in contact with (e.g. direct or through one or more connector pieces) one or more elements within the structural assembly 110 (e.g. vertical support member 111, rear vertical member 117, platform member 121, etc.), mounting assembly 130, and/or accessory assembly 150 (e.g. accessory vertical member 151, accessory side restraint 152, accessory support member 153, accessory side support 154, accessory vertical support 155, accessory base member 156, accessory top restraint 157, etc.).

In some embodiments, the structural assembly 110 comprises one or more rear vertical members 117 (e.g. 1, 2 3, 4, 5, 6, 7, 8, 9, 10, 11, 12 13, 14, 15, 16, 17 18, 19, 20, >20). In some embodiments, rear vertical members 117 are located at the corners of the structural assembly 110. In some embodiments rear vertical members 117 are located along the front, right, left, or rear sides of the structural assembly 110. In some embodiments, rear vertical members 117 extend from the bottom of the structural assembly 110 to the top of the structural assembly 110. In some embodiments, rear vertical members 117 do not extend to the bottom of the structural assembly 110. In some embodiments, rear vertical members 117 do not extend to the top of the structural assembly 110. In some embodiments, rear vertical members 117 are attached to or in contact with other elements within the structural assembly 110 (e.g. front base member 112, front support member 113, side support member 114, rear support member 115, rear restraint member 116, side restraint member 118, upper support member 119, top support member 120, platform member 121, etc.), mounting assembly 130 (e.g. primary lift rod 133, secondary lift rod 134, lift motor 137, side lift member 138, front lift member 139, top lift member 140, retraction member 141, retraction motor 142, etc.), and/or accessory assembly 150 (e.g.

accessory vertical member 151, accessory side restraint 152, accessory support member 153, accessory side support 154, accessory vertical support 155, accessory base member 156, accessory top restraint 157, etc.). In some embodiments, rear vertical members 117 are attached to or in contact with other elements within the structural assembly 110, mounting assembly 130, and/or accessory assembly 150 through connector pieces (e.g. brackets, joints, connectors, screws, etc.).

In some embodiments, the apparatus 100 of the present invention provides one or more platform members 121 (e.g. 1, 2, 3, 4, 5, 6, 7, 8, 9, 10, >10). In some embodiments, a platform member of the present invention is part of the structural assembly 110, mounting assembly 130, accessory assembly 150, and/or bridges 2 or more portions of the apparatus 100 (e.g. structural assembly 110 and accessory assembly 150). In some embodiments, a platform assembly 121 is configured to support a device 100, accessory, or other equipment, devices, apparatus, etc. In some embodiments, a platform assembly 121 is custom designed to fit and/or interact with a specific device 100 (e.g. mass spectrometer (e.g. TOF-MS)). In some embodiments, a platform assembly 121 comprises attachment elements for interacting with a device 100. In some embodiments, a platform assembly 121 provides a generic platform for supporting and interacting with general clinical and research equipment. In some embodiments, a platform assembly is directly or indirectly supported by vertical support members 111, front base members 112, front support members 113, side support members 114, rear support members 115, rear vertical members 117, accessory vertical members 151, accessory support members 153, accessory side supports 154, accessory vertical supports 155, and/or accessory base members 156.

In some embodiments, one or more accessory vertical members 151, accessory support member 153, accessory side support 154, accessory vertical support 155, and/or accessory base member 156 are configured to provide similar functions to the corresponding elements in the structural assembly 110. The accessory elements are configured to support the accessory assembly 150 and any accessory devices, equipment, and/or accessory units. In some embodiments, an apparatus 100 comprises one or more accessory assemblies 150 located on the front, rear, right, or left sides of the structural assembly 110. In some embodiments, an apparatus 100 lacks an accessory assembly 150.

In some embodiments, the mounting assembly 130 comprises one or more device engagement members 131 (e.g. 1, 2, 3, 4, 5, 6, 7, 8, 9, 10, 11, 12 13, 14, 15, 16, 17 18, 19, 20, >20). In some embodiments, device engagement members 131 provide an interface between the mounting assembly 130 and the device 200, during the lifting, retracting, and lowering processes. In some embodiments, a device engagement member 131 comprises a strap, belt, cord, cable, latch, platform, scoop, elevator, arm, etc. In some embodiments, a device engagement member 131 attaches directly to a device 200 (e.g. to the exterior). In some embodiments, a device engagement member 131 traverses around, under, or through a device 200.

In some embodiments, the structural assembly, mounting assembly, and accessory assembly comprise a plurality of materials (e.g. metal, alloys, plastics, etc.). In some embodiments, an apparatus of the present invention comprises one or more metals, alloys, plastics, polymers, natural materials, synthetic materials, fabrics, fibers, etc. In some embodiments, an apparatus of the present invention comprises one or more metals including but not limited to aluminum, antimony, boron, cadmium, cesium, chromium, cobalt, copper, gold, iron, lead, lithium, manganese, mercury, molybdenum, nickel, platinum, palladium, rhodium, silver, tin, titanium, tungsten, vanadium, and zinc. In some embodiments, a device of the present invention comprises one or more alloys including but not limited to alloys of aluminum (e.g., Al—Li, alumel, duralumin, magnox, zamak, etc.), alloys of iron (e.g., steel, stainless steel, surgical stainless steel, silicon steel, tool steel, cast iron, Spiegeleisen, etc.), alloys of cobalt (e.g., stellite, talonite, etc.), alloys of nickel (e.g., German silver, chromel, mu-metal, monel metal, nichrome, nicrosil, nisil, nitinol, etc.), alloys of copper (beryllium copper, billon, brass, bronze, phosphor bronze, constantan, cupronickel, bell metal, Devarda's alloy, gilding metal, nickel silver, nordic gold, prince's metal, tumbaga, etc.), alloys of silver (e.g., sterling silver, etc.), alloys of tin (e.g., Britannium, pewter, solder, etc.), alloys of gold (electrum, white gold, etc.), amalgam, and alloys of lead (e.g., solder, terne, type meta, etc.). In some embodiments, a device of the present invention comprises one or more plastics including but not limited to Bakelite, neoprene, nylon, PVC, polystyrene, polyacrylonitrile, PVB, silicone, rubber, polyamide, synthetic rubber, vulcanized rubber, acrylic, polyethylene, polypropylene, polyethylene terephthalate, polytetrafluoroethylene, gore-tex, polycarbonate, etc. In some embodiments, elements of a device of the present invention a device of the present invention may also comprise glass, textiles (e.g., from animal (e.g. wool), plant (e.g. cotton, flax, etc.), mineral, and/or synthetic sources (e.g. polyester, etc.), liquids, etc.

It is to be understood that the terminology used herein is for the purpose of describing particular embodiments only, and is not intended to be limiting. Further, unless defined otherwise, all technical and scientific terms used herein have the same meaning as commonly understood by one of ordinary skill in the art to which this invention pertains.

1. A system comprising: (a) a device, wherein said device comprises a biomedical, biophysical, or biochemical device; and (b) an apparatus, wherein said apparatus comprises (i) a mounting assembly and (ii) a structural assembly, wherein said structural assembly comprises a platform member, wherein said mounting assembly is configured to lift said device to a height, said height being higher than the height of said platform member, wherein said mounting assembly is configured to retract said device into a position directly above said platform member, wherein said mounting assembly is configured to lower said device onto said platform member, and wherein said structural assembly and said platform member are configured to stably support said device.

2. The system of claim 1, wherein said mounting assembly is supported by said structural assembly.

3. The system of claim 1, wherein said mounting assembly is located atop said structural assembly.

4. The system of claim 1, wherein said mounting assembly comprises a lifting assembly and a retracting assembly.

5. The system of claim 4, wherein said retracting assembly is configured extend said lifting assembly beyond the front of said structural assembly, and wherein said retracting assembly is configured retract said lifting assembly within said structural assembly and above said platform member.

6. The system of claim 5, wherein said lifting assembly comprises one or more device engagement members, wherein said device engagement members extend from said lifting assembly to said device, and wherein said device engagement members are configured to stably engage and support said device.

7. The system of claim 6, wherein said device engagement members are configured to retract toward the top of said system, thereby lifting said device.

8. The system of claim 7, wherein said lifting assembly is configured to lift said device to a height, wherein said height is higher than said platform member.

9. The system of claim 8, wherein said retracting assembly is configured retract said lifting assembly and said device within said structural assembly and directly above said platform member.

10. The system of claim 9, wherein said lifting assembly is configured to extend said device engagement members, thereby setting said device onto said platform member.

11. The system of claim 1, further comprising an accessory assembly, wherein said accessory assembly is configured to support one or more accessory devices, wherein said accessory devices are configured to function in conjunction with said device.

12. The system of claim 11, wherein said accessory assembly is attached to said structural assembly.

13. The system of claim 1, wherein said device comprises a mass spectrometer.

14. An apparatus comprising: (a) a structural assembly and (b) a mounting assembly, wherein said mounting assembly is located atop said structural assembly and said mounting assembly is supported by said structural assembly, wherein said structural assembly comprises a platform member, wherein said mounting assembly comprises a lifting assembly and a retracting assembly, wherein said lifting assembly is configured to lift said device to a height, said height being higher than the height of said platform member, wherein said retracting assembly is configured to retract said lifting assembly and said device into a position directly above said platform member, wherein said lifting assembly is configured to lower said device onto said platform member, and wherein said structural assembly and said platform member are configured to stably support said device.

15. The apparatus of claim 14, wherein said device comprises a mass spectrometer.

16. The apparatus of claim 14, wherein said lifting assembly comprises a device engagement member.

17. A method comprising:
a) providing:
i) an apparatus of claim 16; and
ii) a device;
b) engaging of said device with said device engagement member of said lifting assembly of said apparatus;
c) lifting said device by said lifting assembly of said apparatus, wherein said lifting comprises lifting said device to a height wherein the bottom of said device reaches a height higher than said platform member of said apparatus;
d) retracting said device and said lifting assembly by said retracting assembly, wherein said retracting results in said device being positioned above said platform member; and
e) lowering said device by said lifting assembly of said apparatus, wherein said lowering results in said device being positioned onto said platform member.

18. The method of claim 17, further comprising (f) using said device for its designated purpose.

19. The method of claim 18, wherein said device comprises a mass spectrometer.
